(19) United States
(12) Patent Application Publication
(10) Pub. No.: US 2017/0358244 A1
(43) Pub. Date: Dec. 14, 2017

(54) World Wonders Learning is an Educational Initiative, Curriculum, Program, and Publishing etc

(71) Applicant: Daphne Jean Moore, Chiacago, IL (US)

(72) Inventor: Daphne Jean Moore, Chiacago, IL (US)

(21) Appl. No.: 15/179,976

(22) Filed: Jun. 11, 2016

(51) Int. Cl. G09B 19/00; G09B 19/24; G09B 19/02

(52) U.S. Cl. CPC G09B 19/0069; G09B 19/02; G09B 19/24

(57) ABSTRACT

World Wonders Learning is a new educational program, textbook, curriculum or school design. This educational initiative is created to encourage school officials to give school districts as well as school administrators more autonomy to “Reinvent Existing School designs, from PreK through college could pose a problem if the administrator and or the school community leaders have a problem with envisioning and organizing a new form of school. This World Wonders Learning initiative, which links the News and Business, could also become cumbersome, or difficult if the school does not form partnerships, or seek out this current type of educational type resources on a regular basis.

### IN GENERAL

World Wonders Learning Curriculum is a new PreK-12 educational curriculum and or program, initiative, textbook, based on a new type of school design. World Wonders Learning Curriculum is created to encourage educational writers to design and publish PreK-12 textbooks, including online publication that encourages students into becoming more “Community Conscience.” WWL curriculum and resources would include but not be limited to the including textbook resources such as the media, newspaper and local businesses. The WWL school curriculum would include activities similar to that of activities that are actual performed in an actual business or corporation, for example, an activity whereas students would be encouraged early to work together in collaborative teams. WWL curriculums would specifically gear toward helping students recognize their gifts and talents early in life. The curriculum would provide activities that give students opportunities to investigate community issues, and or real world problems with a specific goal in mind. World Wonders Learning format would also design a unique curriculum that would include lessons that would help student become more financially astute, help student's recognize the “Heads of History,” to use Social Media as a professional resource, and to talk about the current news, as well as novels, and films in their everyday conversations. WWL curriculum or educational textbooks and materials will specifically be crafted to help teachers to “Put STEM in Literacy, and How to get more Bangs for your Buck.”

The Curriculum will ask the students to look at the needs of the community while they explore the legal aspect of the community need and then use problem solving, questioning and wondering techniques to help with solving those real world problems in law, business, government, and community initiatives while at the same time incorporate STEM and other disciplines in the classrooms.

a) I claim WWL Curriculums are Creatively designed and units that help to draw out student's interest, community concerns, scientific wonderings, mathematical dilemmas, technological and engineering advances, giftedness, creativity and entrepreneurships.

b) Multiple access points for students of all levels and abilities to succeed Students ranging from “Diverse Learners” to the “Gifted” child can collaborate with peers and meaningfully activities that contribute to our world's success, simply by generating ideas and possible solutions for business and community concerns and initiatives.

c) Hands-On Relevant Learning Allows students to develop their own evidence and solutions on matters of interest and concern leading to relational understanding. I hear and forget; I see and remember; I do and understand; if it matters to me, I will never forget it

d) World Wonderings Those never ending questions or wondering. Lessons are directed toward students thoughts about the world or thought about the universe, concepts and its designs and it means toward improving it, using todays and future innovations
